(19) United States
(12) Patent Application Publication
(10) Pub. No.: US 2024/0312366 A1
(43) Pub. Date: Sep. 19, 2024

(54) INTERACTIVE READING ASSISTANCE SYSTEM AND METHOD OF USE

(71) Applicant: The Reasearch Institute at Nationwide Children's Hospital, Columbus, OH (US)

(72) Inventors: Prashant Solanki Malhotra, Columbus, OH (US); Janelle Huefner, Powell, OH (US); John Luna, Columbus, OH (US); Anand Satyapriya, Powell, OH (US); Shana Nicole Lucius, Westerville, OH (US)

(21) Appl. No.: 18/575,539

(22) PCT Filed: Jul. 1, 2022
(86) PCT No.: PCT/US2022/035989

§ 371 Date: Dec. 29, 2023

Related U.S. Application Data
(60) Provisional application No. 63/217,584, filed on Jul. 1, 2021.

(51) Int. Cl. G09B 21/00; G06F 40/205; G09B 17/00

(52) U.S. Cl. CPC G09B 21/009; G06F 40/205; G09B 17/006

(57) ABSTRACT

An interactive reading assistance system for assisting hearing impaired users read including an interactive reading assistance device comprising an interactive display defining a touch screen area is presented herein. The interactive reading assistance device includes a processing device having a memory and a processor configured to perform logic functions based upon user inputs on the interactive reading assistance device. One or more texts are parsed by the processing device into text segments, assigned tags, and stored in the memory. The interactive reading assistance device presents the one or more texts to a reader in a recording mode. The interactive reading assistance device presents a prompt to the reader to read and record the text segments identified based upon input therapeutic goals based upon the assigned tags. The recorded text segments are in memory. The recorded text segments are presented as associated with the respective text segments present in the one or more texts.

### CROSS REFERENCES TO RELATED APPLICATIONS

The following application claims priority under 35 U.S.C. § 119 (e) to U.S. Provisional Patent Application Ser. No. 63/217,584 filed Jul. 1, 2021 entitled INTERACTIVE READING ASSISTANCE SYSTEM AND METHOD OF USE. The above-identified application is incorporated herein by reference in its entirety for all purposes.

### TECHNICAL FIELD

The present disclosure generally relates to an interactive reading assistance system and method of use, and more particularly, to an interactive reading assistance system for monitoring, assessing, and/or facilitating language acquisition especially in persons with hearing impairment.

### BACKGROUND

Two to three children for every one thousand live births are born with hearing impairment. Stated another way, there is an estimated one to three million children in the United States (US) and about thirty four million children globally that are hearing impaired. Children with hearing loss are at risk for poor speech, language, and literacy outcomes. Guided, intensive auditory training and individualized therapy can reduce the risk of poor speech, language, and literacy outcomes. Typically, access to a speech language therapist with expertise in pediatric hearing loss is limited, and existing therapies require a speech language therapist to be effective.

### SUMMARY

One aspect of the present disclosure comprises an interactive reading assistance system for assisting users read, the interactive reading assistance system comprises an interactive reading assistance device comprising an interactive display defining a touch screen area, and a processing device in communication with the interactive reading assistance device. The processing device has a processor configured to perform logic functions based upon user inputs on the interactive reading assistance device. The processing device comprises memory, wherein the one or more texts are parsed into at least one of intermediate text segments, identified elements, and speech sound elements, that are collectively assigned tags, and stored in the memory. The processing device providing instruction to the interactive reading assistance device to present the one or more texts to a reader in a recording mode, presenting a prompt to the reader to read and record at least one of intermediate text segments, identified elements, and speech sound elements identified based upon input therapeutic goals, based upon the assigned tags, storing the recorded at least one of intermediate text segments, identified elements, and speech sound elements in memory, matching the recorded at least one of intermediate text segments, identified elements, and speech sound elements to the at least one of intermediate text segments, identified elements, and speech sound elements present in the one or more texts, providing instruction to the interactive reading assistance device to present the one or more texts to a user in a reading mode, responsive to the user selecting a text of the one or more texts, present options to view the recorded at least one of intermediate text segments, identified elements, and speech sound elements associated with the respective at least one of intermediate text segments, identified elements, and speech sound elements, and responsive to the user selection of an option to view a respective intermediate text segment, identified element, or speech sound element playing the recording matched to that respective intermediate text segment, identified element, or speech sound element.

Another aspect of the present disclosure comprises a non-transitory computer readable medium storing instructions executable by an associated processor to perform a method for implementing an interactive reading assistance system. The method comprising parsing one or more texts into at least one of intermediate text segments, identified elements, and speech sound elements, assigning tags to the intermediate text segments, the identified elements, and the speech sound elements, identifying a population of a user, and assigning a therapeutic objective tag to the user to identify the user population. The method further comprises wherein responsive to interaction of the user with a particular intermediate text segments, identified elements, and speech sound elements, identifying the interaction as successful or unsuccessful within the population of the user, ranking particular intermediate text segments, identified elements, and speech sound elements based upon number of successful interactions identified, and generating a population specific text comprising the intermediate text segments, identified elements, and speech sound elements having a rank over a rank threshold.

Another aspect of the present disclosure comprises a non-transitory computer readable medium storing instructions executable by an associated processor to perform a method for implementing an interactive reading assistance system. The method comprising parsing one or more texts into at least one of intermediate text segments, identified elements, and speech sound elements, assigning one or more assigned tags to the parsed intermediate text segments, identified elements, and speech sound elements, providing instruction to an interactive reading assistance device of the interactive reading assistance system to present the one or more texts to a reader in a recording mode, and presenting a prompt to the reader to read and record at least one of intermediate text segments, identified elements, and speech sound elements identified based upon input therapeutic goals based upon the assigned tags. The method further including storing the recorded at least one of intermediate text segments, identified elements, and speech sound elements in memory, matching the recorded at least one of intermediate text segments, identified elements, and speech sound elements to the at least one of intermediate text segments, identified elements, and speech sound elements present in the one or more texts, and providing instruction to the interactive reading assistance device to present the one or more texts to a user in a reading mode. The method additionally includes providing a text selection option to the user on the interactive reading assistance device, responsive to receiving a user selection of the text selection option, providing instruction to the interactive reading assistance device to present one or more highlightable section elements to the user, providing an auditory training element option to the user on the interactive reading assistance device, and responsive to receiving a selection of the auditory training element, providing instruction to the interactive reading assistance device to audibly recite the recorded at least one of intermediate text segments, identified elements, and speech sound elements that corresponds to the auditory training element selected.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a schematic diagram of an interactive reading assistance system for supporting an interactive reading assistance device, in accordance with one example embodiment of the present disclosure;

FIG. 2 illustrates a flow diagram for a method of identifying and tagging text in an interactive reading assistance system in accordance with one example embodiment of the present disclosure;

FIG. 3 illustrates a flow diagram for a method of identifying text, tagging text, and presenting therapeutically relevant text to reader in an interactive reading assistance system in accordance with one example embodiment of the present disclosure;

FIG. 4A illustrates a flow diagram for a method of recording and editing therapeutically relevant text by a reader in an interactive reading assistance system in accordance with one example embodiment of the present disclosure;

FIG. 4B illustrates a flow diagram for a method of recording and editing therapeutically relevant text by a reader in an interactive reading assistance system in accordance with one example embodiment of the present disclosure;

FIG. 5A illustrates an interactive reading assistance device presentation utilizing an initiation mode generated by an example interactive reading assistance system, according to one example embodiment of the present disclosure;

FIG. 5B illustrates a first recording mode interactive reading assistance device presentation utilizing a recording mode generated by an example interactive reading assistance system, according to one example embodiment of the present disclosure;

FIG. 5C illustrates a second recording mode interactive reading assistance device presentation utilizing a recording mode and a first intermediate text segment generated by an example interactive reading assistance system, according to one example embodiment of the present disclosure;

FIG. 5D illustrates a third recording mode interactive reading assistance device presentation utilizing a recording mode recording a reader reading a first intermediate text segment generated by an example interactive reading assistance system, according to one example embodiment of the present disclosure;

FIG. 5E illustrates a fourth recording mode interactive reading assistance device presentation utilizing a recording mode and a second intermediate text segment generated by an example interactive reading assistance system, according to one example embodiment of the present disclosure;

FIG. 5F illustrates a fifth recording mode interactive reading assistance device presentation utilizing a recording mode and a first identified element generated by an example interactive reading assistance system, according to one example embodiment of the present disclosure;

FIG. 5G illustrates a sixth recording mode interactive reading assistance device presentation utilizing a review mode having a review panel presenting one or more intermediate text segments generated by an example interactive reading assistance system, according to one example embodiment of the present disclosure;

FIG. 5H illustrates a seventh recording mode interactive reading assistance device presentation utilizing recording mode and a review panel presenting one or more intermediate text segments generated by an example interactive reading assistance system, according to one example embodiment of the present disclosure;

FIG. 5I illustrates an eighth recording mode interactive reading assistance device presentation utilizing recording mode and a review panel presenting one or more intermediate text segments and one or more identified elements generated by an example interactive reading assistance system, according to one example embodiment of the present disclosure;

FIG. 5J illustrates a ninth recording mode interactive reading assistance device presentation utilizing a review mode having a review panel presenting one or more intermediate text segments and one or more identified elements generated by an example interactive reading assistance system, according to one example embodiment of the present disclosure;

FIG. 6A illustrates a first part of a flow diagram for a method of utilizing a reading mode of an interactive reading assistance device presented by an example interactive reading assistance system, according to one example embodiment of the present disclosure;

FIG. 6B illustrates a second part of a flow diagram for a method of utilizing a reading mode of an interactive reading assistance device presented by an example interactive reading assistance system, according to one example embodiment of the present disclosure;

FIG. 7A illustrates an interactive reading assistance device presentation utilizing an initiation mode of a reading mode generated by an example interactive reading assistance system, according to one example embodiment of the present disclosure;

FIG. 7B illustrates an interactive reading assistance device presentation utilizing a speech sound element test of a reading mode generated by an example interactive reading assistance system, according to one example embodiment of the present disclosure;

FIG. 7C illustrates an interactive reading assistance device presentation presenting a speech sound element test completion element of a reading mode generated by an example interactive reading assistance system, according to one example embodiment of the present disclosure;

FIG. 7D illustrates a first screen of an interactive reading assistance device presentation utilizing reading mode generated by an example interactive reading assistance system, according to one example embodiment of the present disclosure;

FIG. 7E illustrates a second screen of an interactive reading assistance device presentation utilizing reading mode generated by an example interactive reading assistance system, according to one example embodiment of the present disclosure;

FIG. 7F illustrates a third screen of an interactive reading assistance device presentation utilizing reading mode generated by an example interactive reading assistance system, according to one example embodiment of the present disclosure;

FIG. 7G illustrates a fourth screen of an interactive reading assistance device presentation utilizing reading mode generated by an example interactive reading assistance system, according to one example embodiment of the present disclosure;

FIG. 7H illustrates a fifth screen of an interactive reading assistance device presentation utilizing reading mode generated by an example interactive reading assistance system, according to one example embodiment of the present disclosure;

FIG. 7I illustrates a sixth screen of an interactive reading assistance device presentation utilizing reading mode generated by an example interactive reading assistance system, according to one example embodiment of the present disclosure;

FIG. 7J illustrates a seventh screen of an interactive reading assistance device presentation utilizing reading mode generated by an example interactive reading assistance system, according to one example embodiment of the present disclosure;

FIG. 7K illustrates an eighth screen of an interactive reading assistance device presentation utilizing reading mode generated by an example interactive reading assistance system, according to one example embodiment of the present disclosure;

FIG. 7L illustrates a ninth screen of an interactive reading assistance device presentation utilizing reading mode generated by an example interactive reading assistance system, according to one example embodiment of the present disclosure;

FIG. 7M illustrates a tenth screen of an interactive reading assistance device presentation utilizing reading mode generated by an example interactive reading assistance system, according to one example embodiment of the present disclosure;

FIG. 7O illustrates an eleventh screen of an interactive reading assistance device presentation utilizing reading mode generated by an example interactive reading assistance system, according to one example embodiment of the present disclosure; and

FIG. 8 illustrates a flow diagram for a method of using the interactive reading assistance system 100, including inputs and outputs utilized in ranking text, intermediate text segments, one or more identified elements, and/or one or more speech sound elements in accordance with one example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure generally relates to an interactive reading assistance system and method of use, and more particularly, to an interactive reading assistance system for monitoring, assessing, and/or facilitating language acquisition especially in persons with hearing impairment.

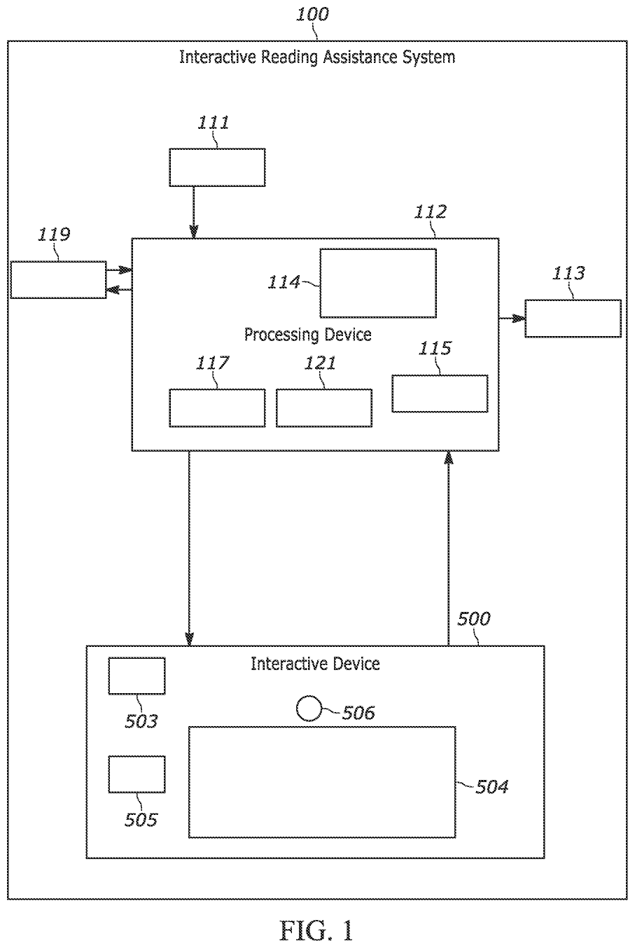

FIG. 1 illustrates a schematic diagram of an interactive reading assistance system 100, in accordance with one of the exemplary embodiments of the disclosure. The interactive reading assistance system 100 includes a processing device 112, which includes a computing device 115 (e.g. a database server, a file server, an application server, a computer, or the like) with computing capability and/or a processor 114. The processor 114 comprises central processing units (CPU), such as a programmable general purpose or special purpose microprocessor, and/or other similar device or a combination thereof.

The processing device 112 would generate outputs 113 based upon inputs 111 received from an interactive reading assistance device 500, cloud storage, a local input form a user, etc. The processing device 112 may be a part of the interactive reading assistance device 500 or separate from it. It would be appreciated by those having ordinary skill in the art that the processing device 112 would include a data storage device 117 in various forms of non-transitory, volatile, and non-volatile memories, which would store buffered or permanent data as well as compiled programming codes used to execute functions of the processing device 112. In another example embodiment, the data storage device 117 can be external to and accessible by the processing device 112, the data storage device 117 may comprise an external hard drive, cloud storage, and/or other external recording devices 119. The data storage device 117 is coupled to a camera, video recorder and/or recording device 506, a microphone 503, and/or a speaker 505. Wherein the data storage device 117 stores audio and visual images captured by the camera or recording device 506, and/or the microphone 503.

In one example embodiment, the processing device 112 comprises one of a remote or local computer system 121. The computer system includes desktop, laptop, tablet hand-held personal computing device, LAN, WAN, WWW, and the like, running on any number of known operating systems and are accessible for communication with remote data storage, such as a cloud, host operating computer, via a world-wide-web or Internet.

In another example embodiment, the processing device 112 comprises a processor, a microprocessor, a data storage, computer system memory that includes random-access-memory (“RAM”), read-only-memory (“ROM”) and/or an input/output interface. The processing device 112 executes instructions by non-transitory computer readable medium either internal or external through the processor that communicates to the processor via input interface and/or electrical communications, such as from the interactive reading assistance device 500. In yet another example embodiment, the processing device 112 communicates with the Internet, a network such as a LAN, WAN, and/or a cloud, input/output devices such as flash drives, remote devices such as a smart phone or tablet, and displays. In yet another example embodiment, the processing device 112 includes one or more databases that track interaction with the interactive reading assistance device 500. The interactive reading assistance device 500 (e.g., a tablet or smart phone) includes an interactive display 504, the display for receiving tactile input (e.g., a touch screen, a capacitive sense screen and/or the like).

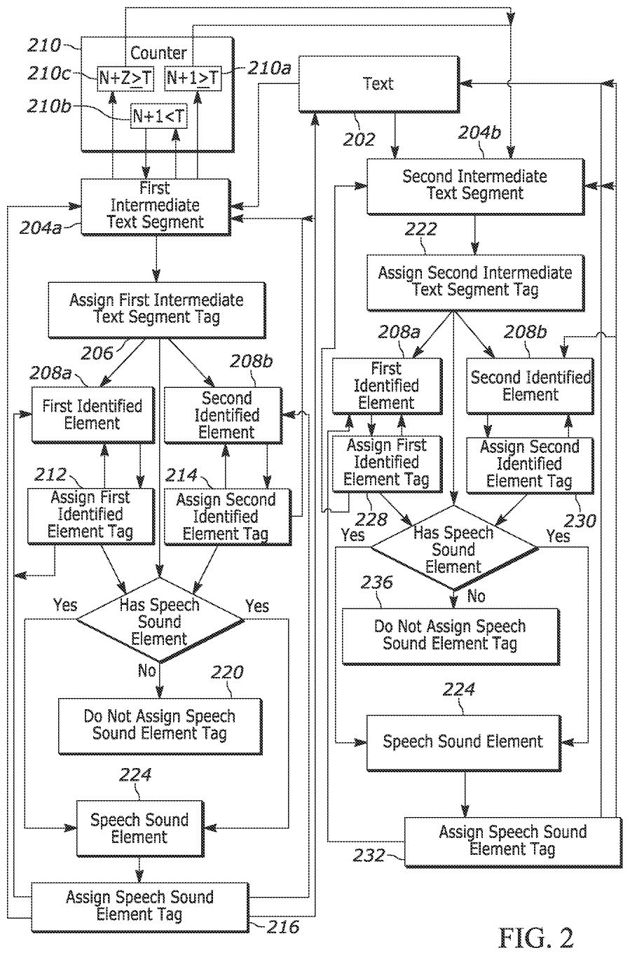

As illustrated in FIG. 2, a method 200 of parsing text 202 into one or more intermediate text segments 204, one or more identified elements 208, and/or one or more speech sounds is illustrated. In method 200 the text 202 is selected. In one example embodiment, the text 202 is at least one of a book, an article, a manuscript, a poem, a story, etc. In another example embodiment, the text 202 is at least one of a book, an article, a manuscript, a poem, a story, etc. set to music. In yet another example embodiment, the text 202 is a song, including music and lyrics. The processing device 112 parses the text 202 into one or more intermediate text segments 208, such as a first intermediate text segment 204a and a second intermediate text segment 204b. In one example embodiment, a counter 210 counts a number of units N (words, characters, syllables, or the like), responsive to N+1, wherein 1 is a number of sentence ending indicators (e.g., exclamation point, period, and/or question mark) present, being greater than or equal to a threshold T, the first intermediate segment 204a is created. The threshold T, which is an assigned number of words, characters, syllables, or the like, is identified based upon the text 202 selected, an age and/or therapeutic objective of a user (e.g., the person who will be utilizing a reading mode 716, described in detail below). In one example embodiment, the therapeutic objective of the user is to overcome a learning impairment or difficulty, such as one of hearing impairment (HI), autism, or dyslexia. In another example embodiment, the therapeutic objective of the user is to learn English or a non-native language, or enhance the reading skills of users who are reading delayed for various reason. In another example embodiment, the therapeutic objective of the user is to read more often, or find more enjoyment in reading. In this case, the user is a developmentally normal child or adult.

In this embodiment, the first intermediate segment 204a is one sentence. Wherein the counter 210 determines that N+1≥T 210a (N+1 is greater than or equal to the threshold T), the processing device 112 having created the first intermediate text segment 204a, begins parsing the text 202, beginning after the text 202 comprising the first intermediate text segment, into the second intermediate text segment 204b.

In another example embodiment, the counter 210 counts the number of units N, responsive to N+1<T 210b (N+1 being less than the threshold T), the processing device 112 proceeds to determine whether N+2 is greater than or equal to the threshold T. The processing device 112 repeats with the number of sentence ending indicators being increased by one iteratively until N+Z≥T 210c, wherein Z is the number of sentence ending indicators present when N+Z is greater than or equal to the threshold T. Once the counter 210 indicates to the processing device 112 that N+Z≥T 210c, the first intermediate segment 204a is created. In this embodiment, the first intermediate segment 204a is Z sentences.

Once the processing device 112, utilizing the counter 210, identifies the first and second intermediate segments 204a, 204b, the processing device assigns a first intermediate text segment tag 206 to the first intermediate text segment, and a second intermediate text segment tag 222 to the second intermediate text segment. The intermediate text segments 204 with the assigned intermediate text segment tags 206, 222 are stored on computing device 115.

In one example embodiment, the processing device 112 recognizes or searches for identified elements 208 (e.g., nouns, verbs, articles, proper nouns, or the like) from the text 202. In another example embodiment, the processing device 112 identifies a first identified element 208 within the first intermediate text segment 204a and assigns a first identified element tag 212 (e.g., including the location of the first identified element in the text 202, in the first intermediate text segment, the type of identified element, including part of speech, etc.) to the first identified element 208a and to the first intermediate text segment. When present, the processing device 112 identifies a second identified element 208b within the first intermediate text segment 204a and assigns a second identified element tag 214 to the second identified element 208a and to the first intermediate text segment 204a. When present, the processing device 112 identifies X1 number of identified element 208, wherein X1 equals the number of identified elements present in the first intermediate text segment, and assigns an X1 number of individual element tags to the respective identified elements, and to the first intermediate segment 204a.

In this embodiment, the processing device 112 identifies, when present, first and second identified elements 208a, 208b within the second intermediate text segment 204b and assigns a first identified element tag 228 to the first identified element 208a and to the second intermediate text segment and assigns a second identified element tag 230 to the second identified element 208b and the second intermediate text segment. When present, the processing device 112 identifies X2 number of identified element 208, wherein X2 equals the number of identified element present in the second intermediate text segment and assigns X2 number of individual element tags to the respective identified elements, and to the second intermediate segment 204b. The identified and tagged identified elements 208, as well as the identified element tags assigned to the first and second text segments 204a, 204b are stored on the computing device 115.

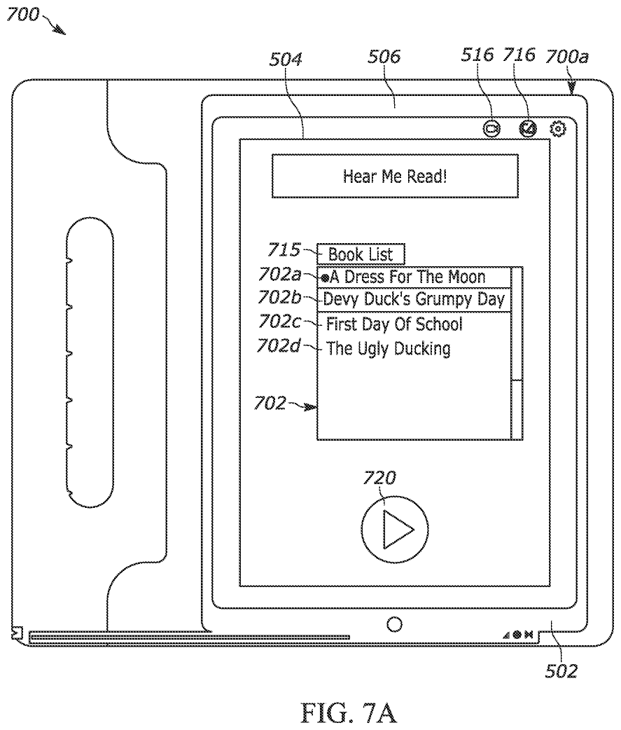

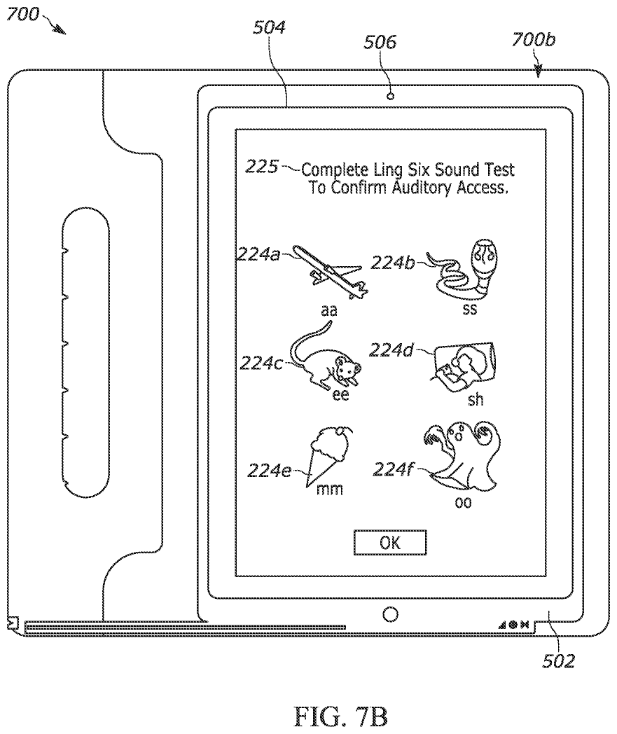

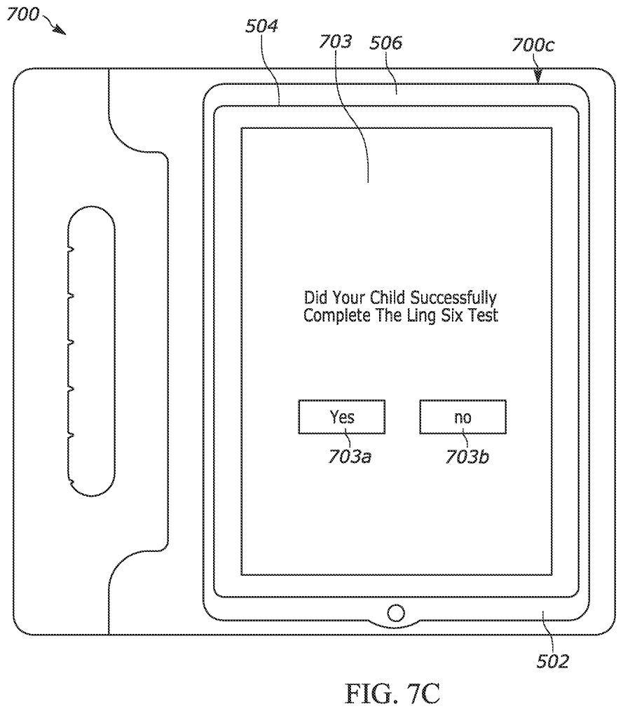

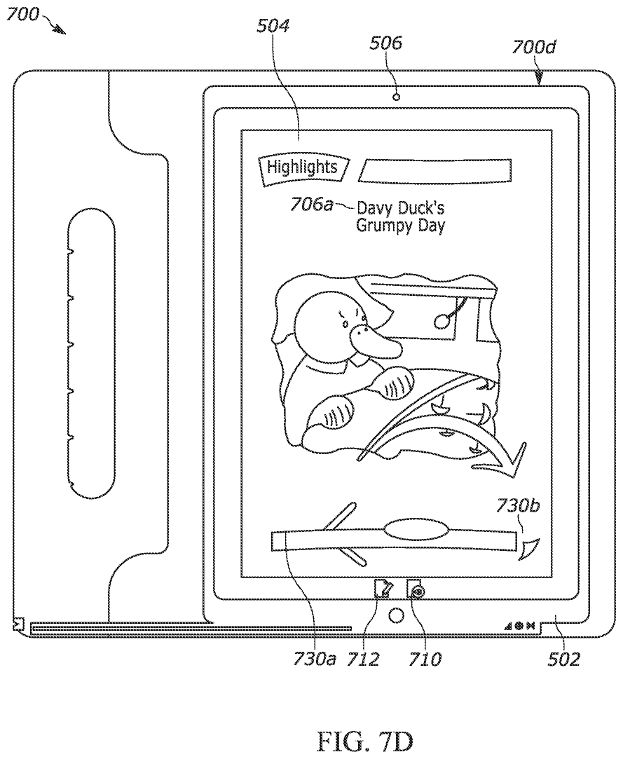

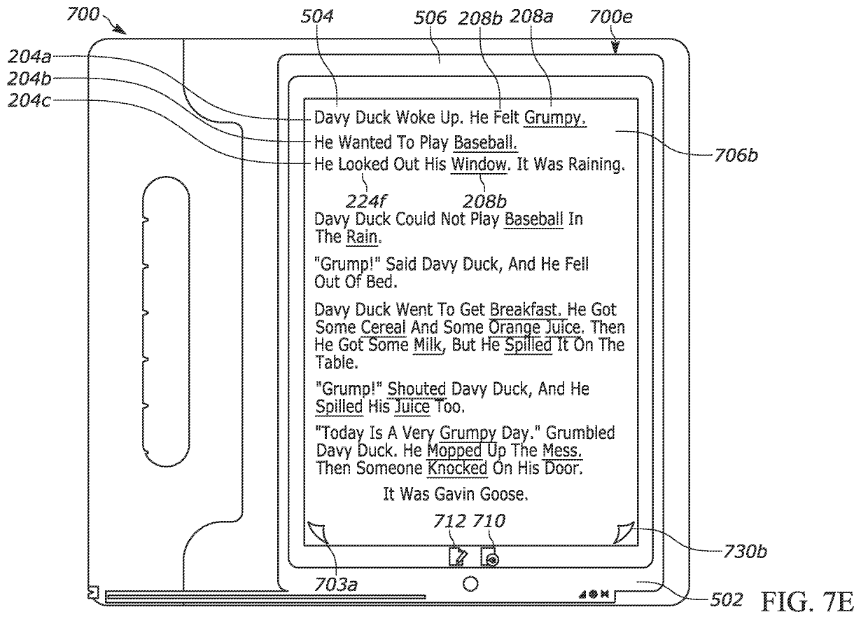

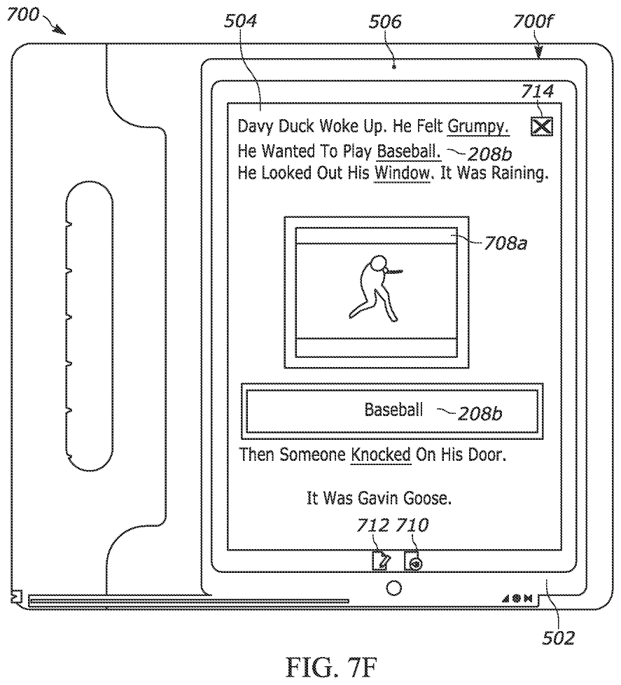

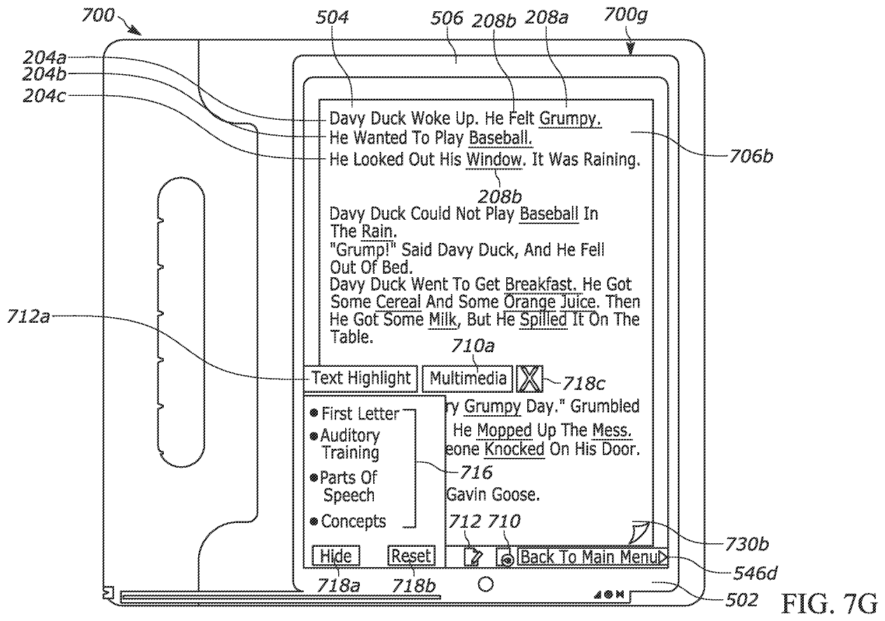

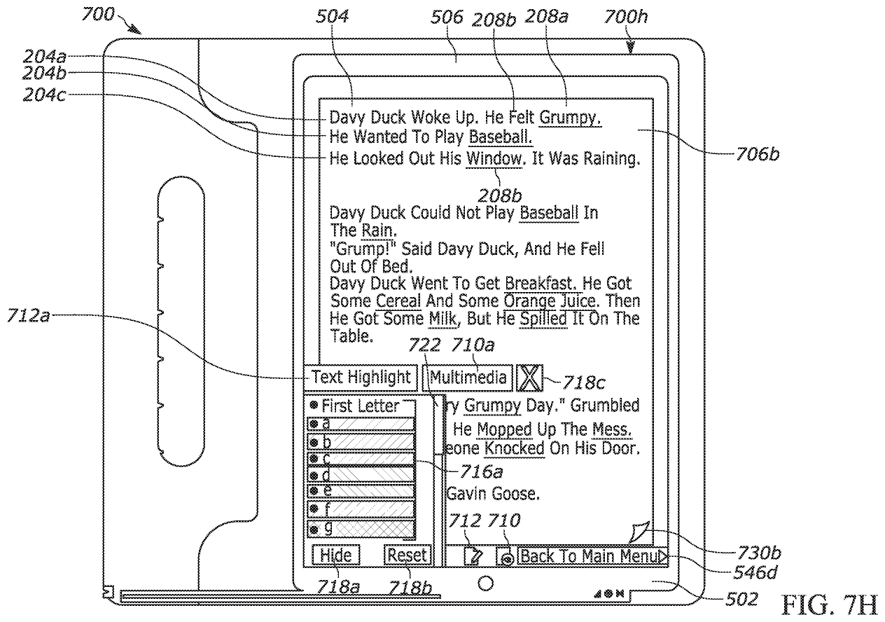

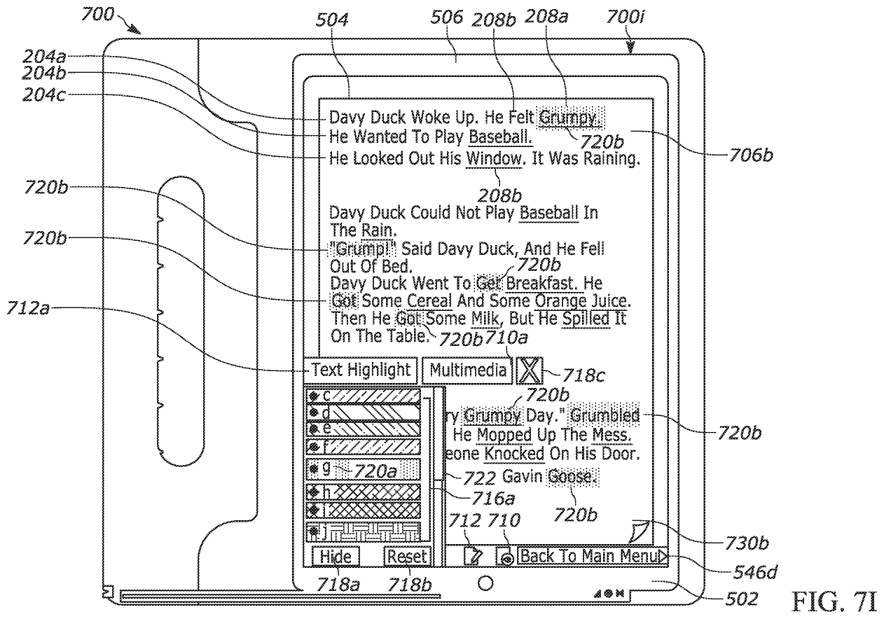

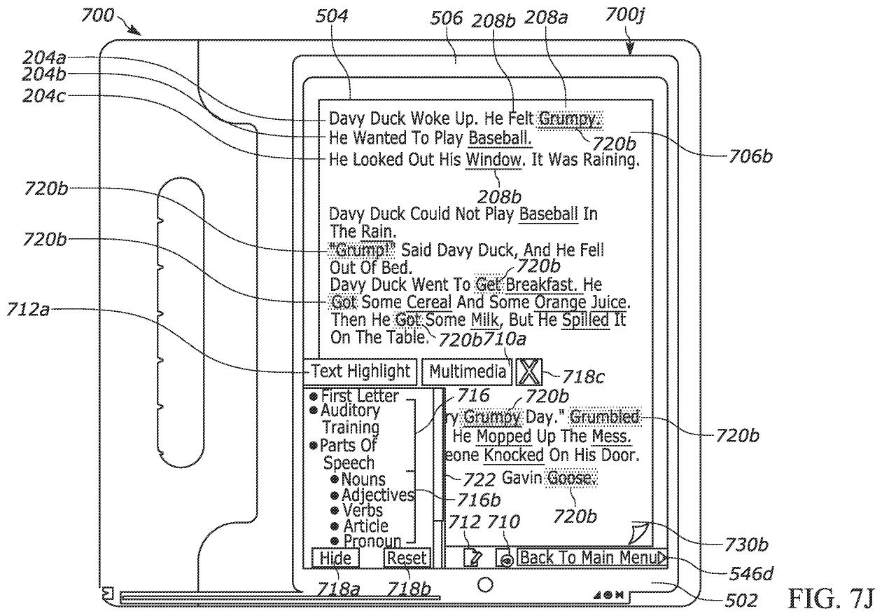

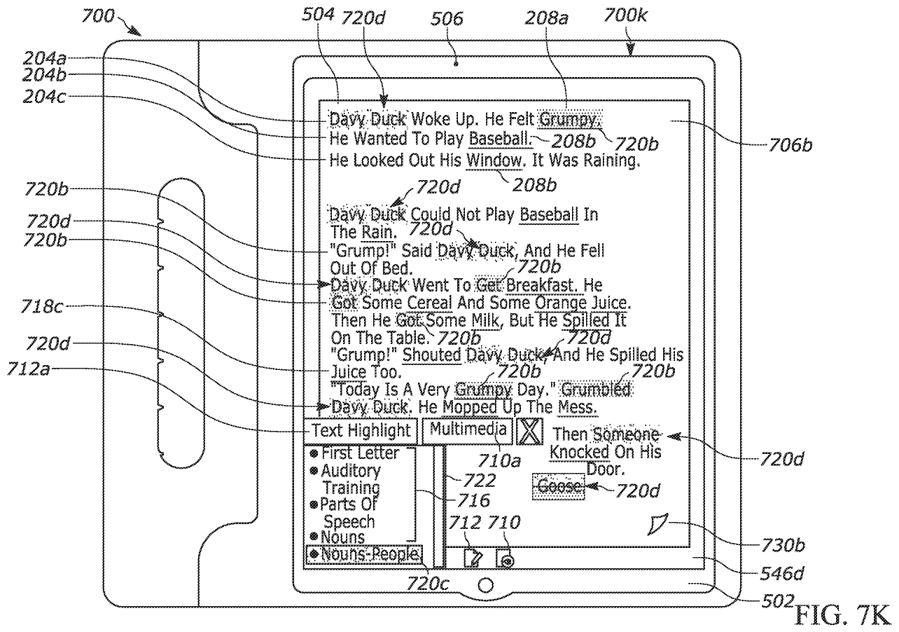

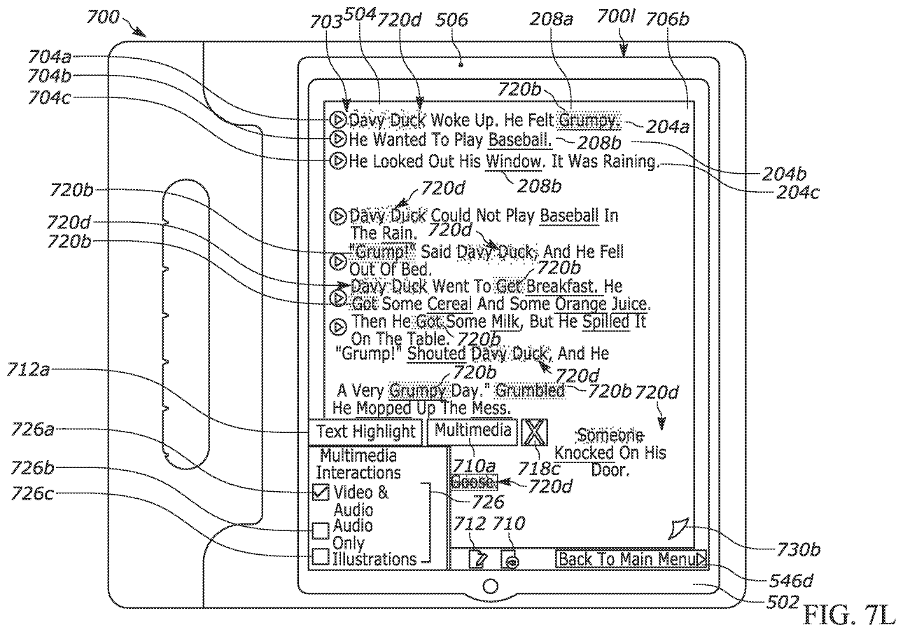

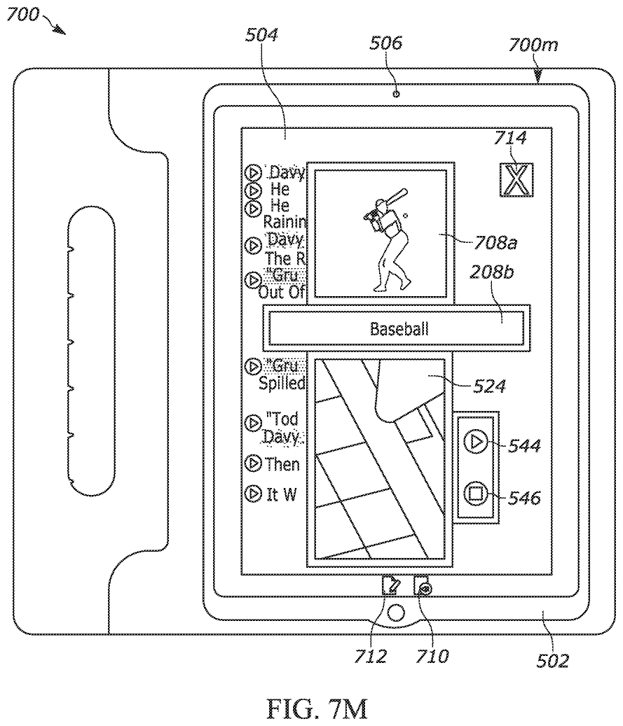

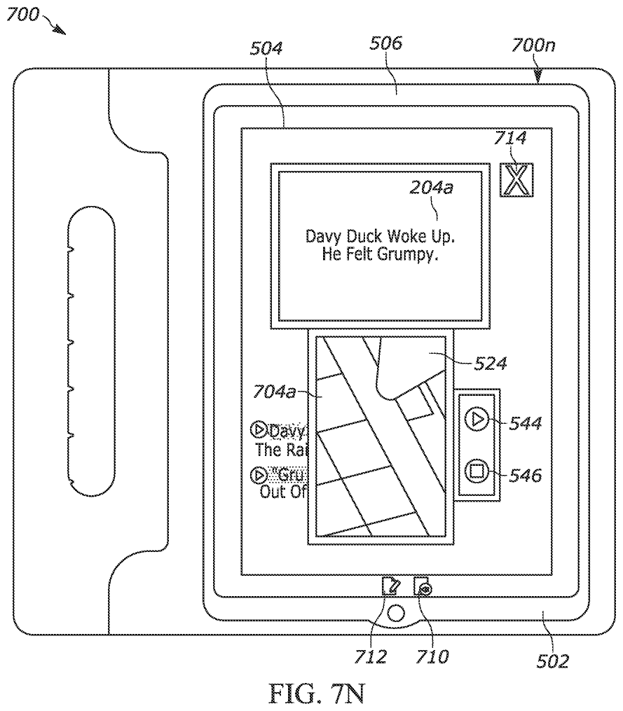

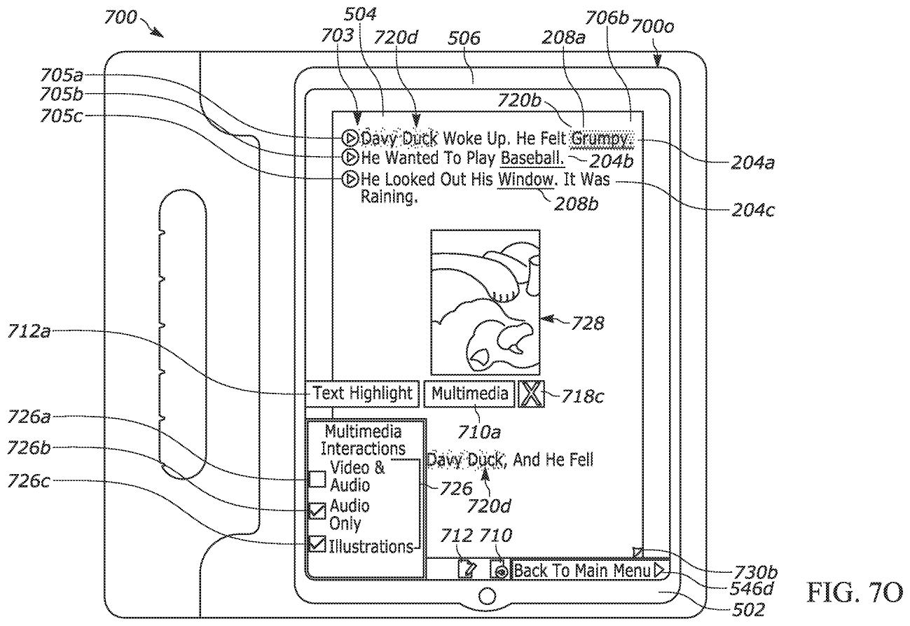

In one example embodiment, the processing device 112 determines if particular speech sound elements 224 (e.g., such as aa sounds 224a, ss sounds 224b (plural sounds), ee sounds 224c, sh sounds 224d, mm sounds 224e, oo sounds 224f, or the like, see FIG. 7B) are present in respective text segments 204, or from the text 202 in general. At 220, responsive to the speech sound element 224 not being present in the first intermediate text segment 204a, the processing device 112 does not assign a speech sound element tag to the intermediate text segment 204a. Responsive to the speech sound element 224 being present in the first intermediate text segment 204a, the processing device 112 assigns speech sound element tag 216 to a word identified as having a particular speech sound, to the intermediate text segment 204a, and to the text 202. The speech sound element tag 216 includes the location of the speech sound element 224 in the text 202, in the first intermediate text segment, the type of speech sound, etc. Responsive to the identified speech sound element 224 being present in an identified element 208, the identified element is tagged with the speech sound element tag.

When present, the processing device 112 identifies multiple speech sounds within the second intermediate text segment 204b and assigns speech sound element tags to the respective multiple speech sounds, as well as to the second intermediate text segment 204b, the text 202, and wherein the speech sound element 224 is present in an identified element 208 to the identified element. At 236, responsive to the speech sound element 224 not being present in the second intermediate text segment 204b, the processing device 112 does not assign a speech sound element tag to the second intermediate text segment 204b. Responsive to the speech sound element 224 being present in the second intermediate text segment 204b, the processing device 112 assigns speech sound element tag 232 to a word identified as having a particular speech sound to the second intermediate text segment 204b, and to the text 202. The speech sound element tag 232 includes the location of the speech sound element 224 in the text 202, in the second intermediate text segment, the type of speech sound, etc. Responsive to the identified speech sound element 224 being present in an identified element 208, the identified element is tagged with the speech sound element tag. The identified and tagged speech sound elements 224, as well as the speech sound elements tags assigned to the identified elements 208, to the first and second text segments 204a, 204b, and to the text 202 are stored in the computing device 115.

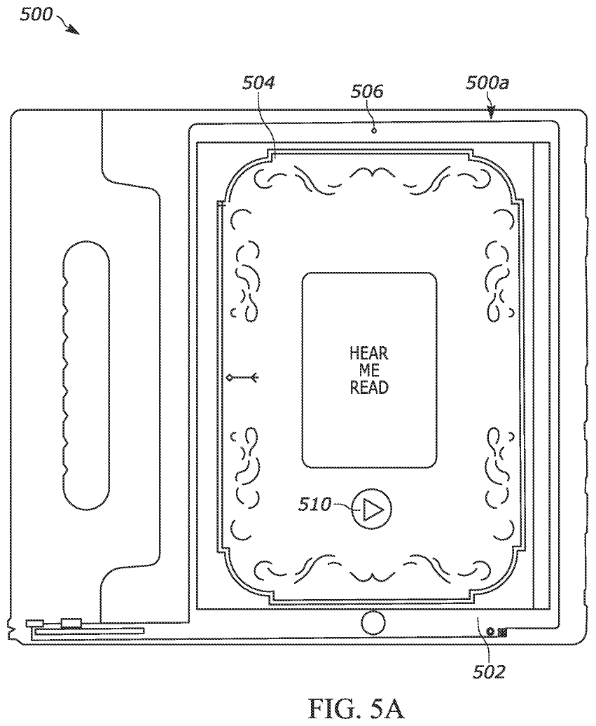

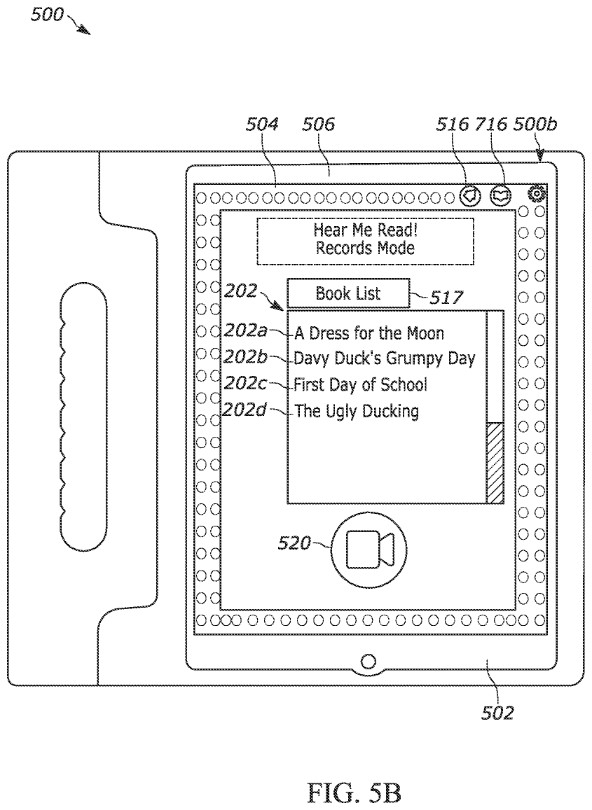

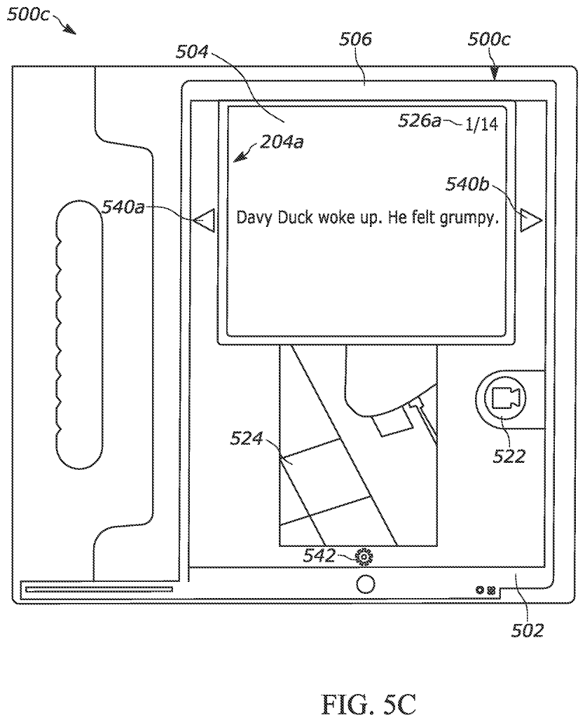

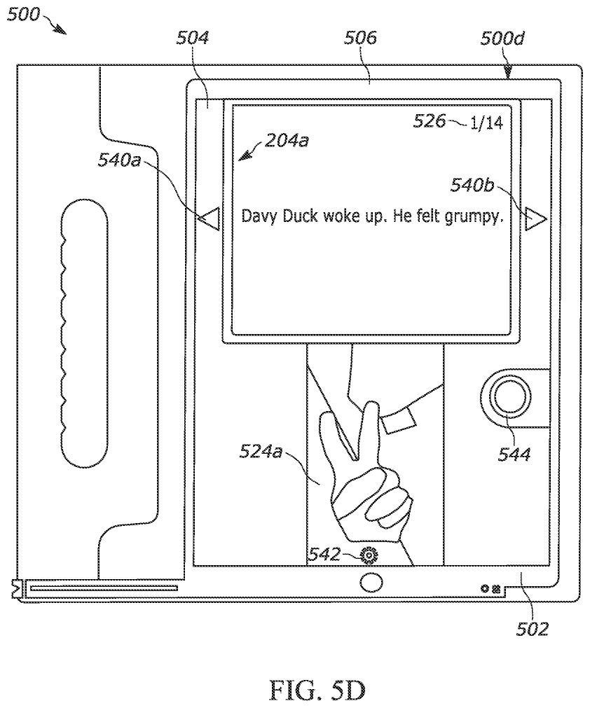

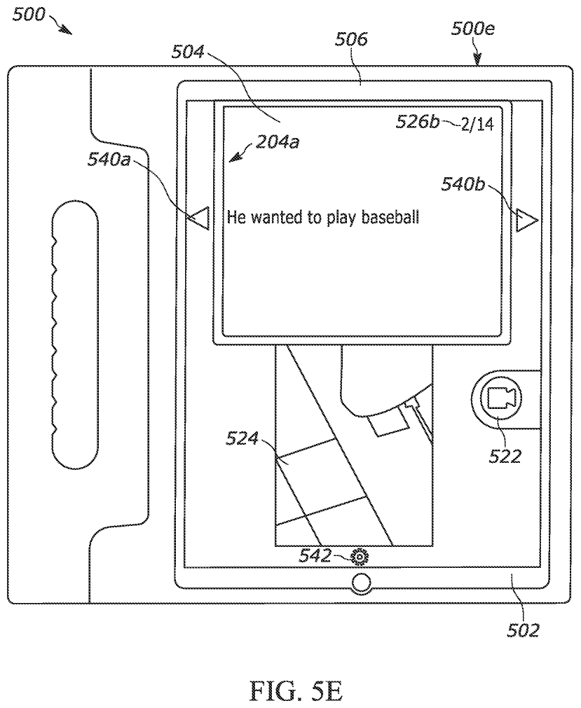

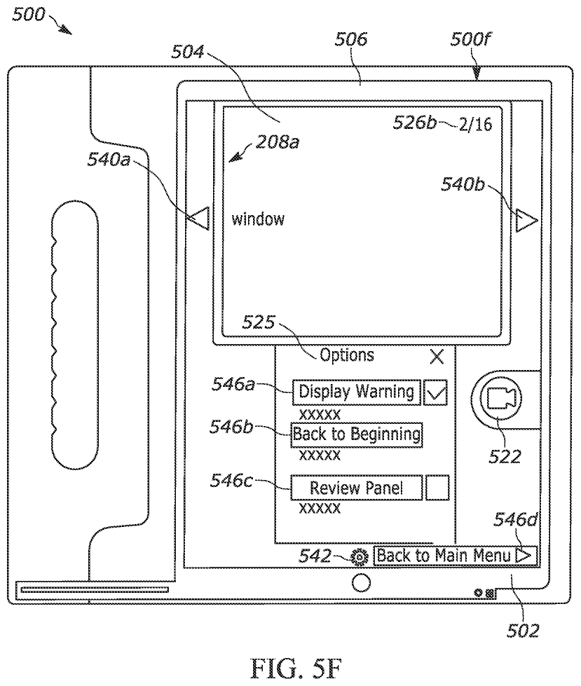

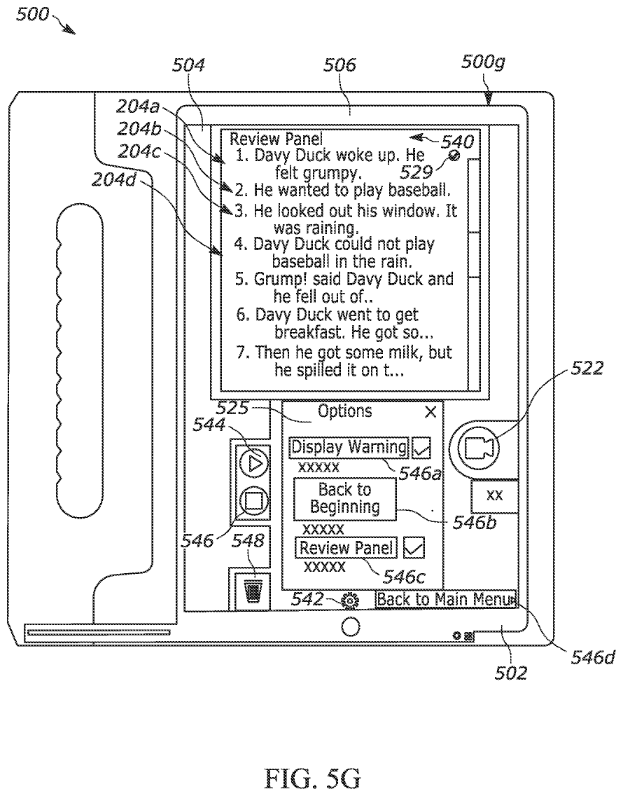

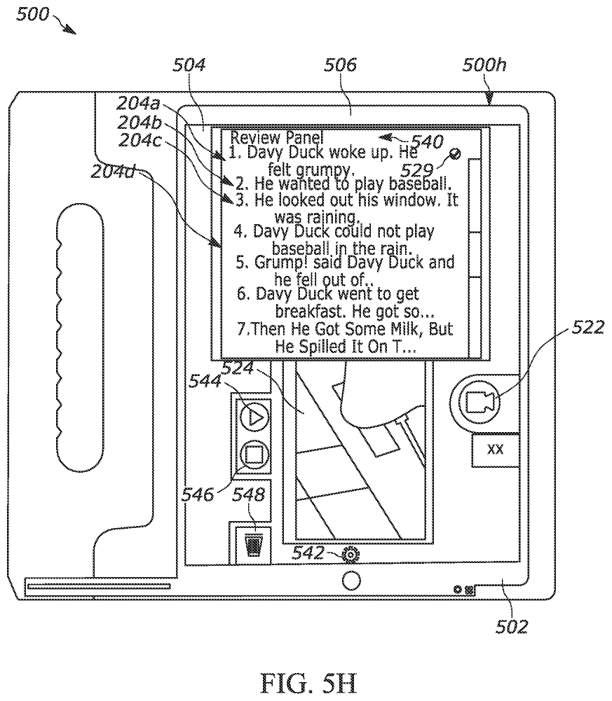

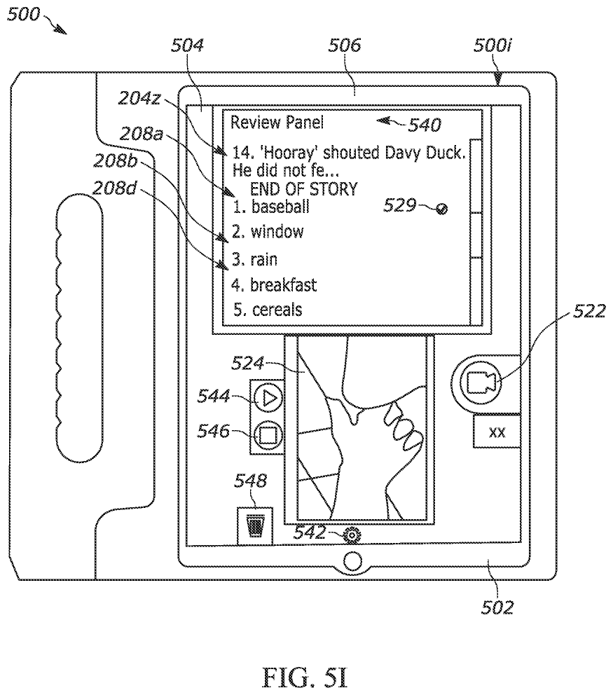

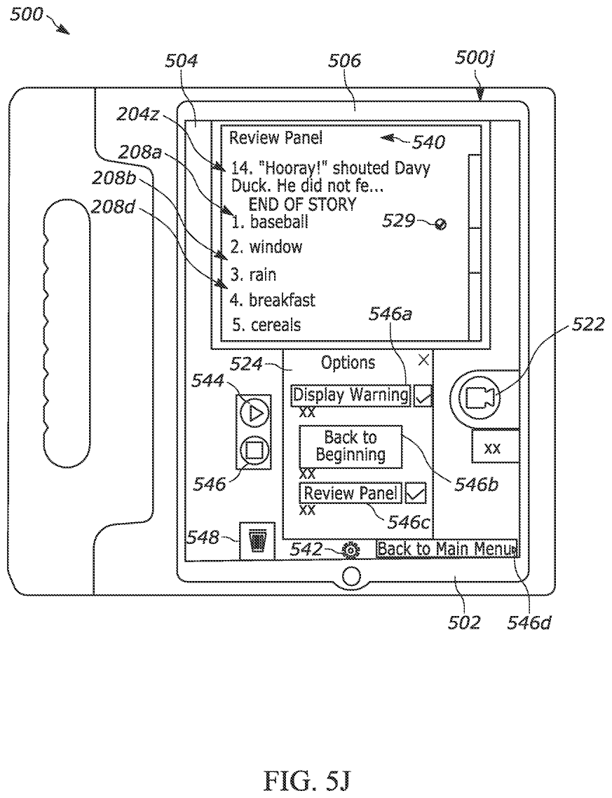

In one example embodiment, such as illustrated in FIGS. 5B, and 5E, the text 202 is “Dave Duck's Grumpy Day” and the second text segment 204a is “He wanted to play baseball.” In this example embodiment, the identified element 208 is a noun, which is “baseball”. Further, an identified ss sound speech sound element 224 is identified, which is also “baseball”. In this example embodiment, the text 202 and the second intermediate segment 204b have speech sound element tags for the ss sound, the word baseball has a both a speech sound element tag designating the ss sound and an identified element tag designating a noun, as well as both designating the location of the word baseball.

In another example embodiment, the processing device 112 parses the text 202 in a bottom up manner, such that the speech sound element 224 and/or identified elements 208 are identified and assigned tags, followed by designating intermediate text segments 204 and assigning tags.

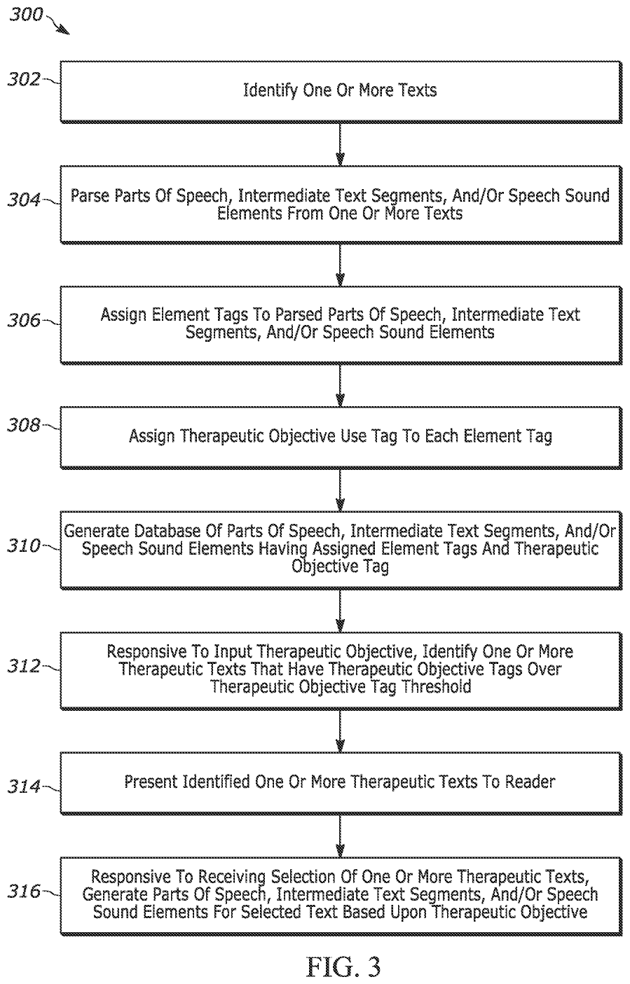

Illustrated in the example method 300 of FIG. 3, is a method of identifying texts 202 based upon input therapeutic objectives. At 302, one or more texts 202 are identified. At 304, parts of speech (e.g., identified elements 208), intermediate text segments 204, and/or speech sound elements 224 are identified from the one or more texts 202. At 306, element tags are assigned to the parsed parts of speech, intermediate text segments 204, and/or the speech sound element 224. At 308, a therapeutic objective tag is assigned to each element tag. For example, if the therapeutic objective is to be better at ss sounds, then the speech sound elements 224 having been assigned speech sound element tags that indicated a ss sound will be assigned a ss sound therapeutic objective tag. At 310, a database (e.g., stored on the computing device 115) is generated having parts of speech (e.g., identified elements 208), intermediate text segments 204, and/or speech sound elements 224 having assigned element tags and/or therapeutic objective tags. At 312, responsive to an input therapeutic objective, one or more therapeutic texts are identified having a number of therapeutic objective tags over a therapeutic objective threshold (e.g., the therapeutic texts having 5 ss sounds present, wherein the threshold is 4 ss sounds). At 314, one or more therapeutic texts are presented to the reader. At 316, responsive to receiving a selection of one or the one or more therapeutic texts, parts of speech, intermediate text segments 204, and/or speech sound elements 224 are generated for the selected therapeutic text based upon the therapeutic objectives.

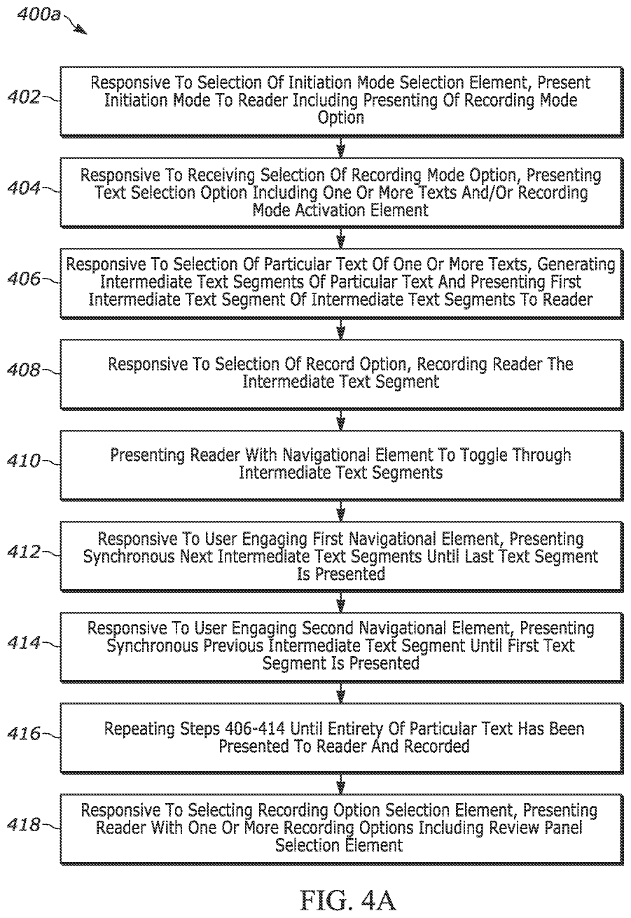

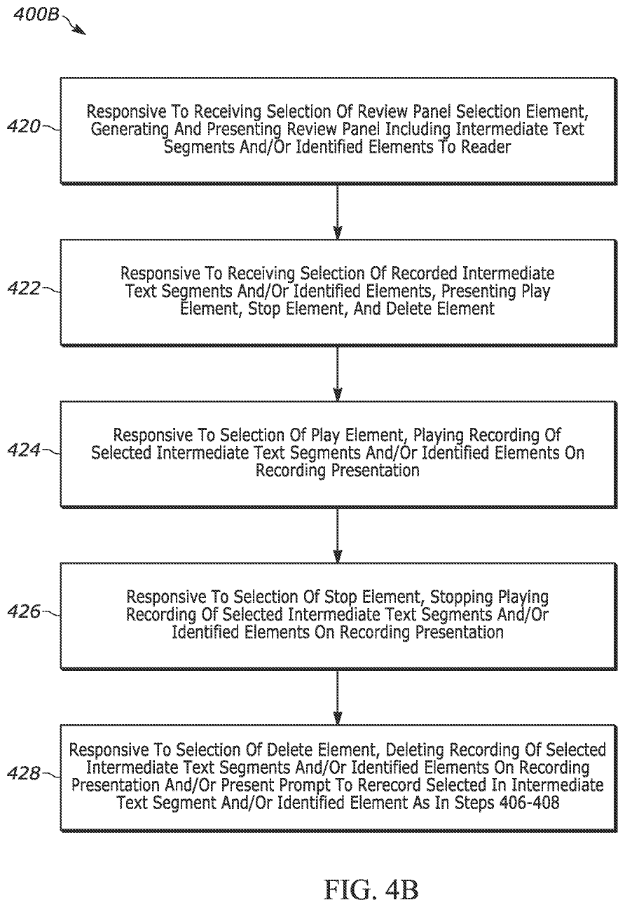

Illustrated in the example method 400a continuing as 400b in FIGS. 4A-4B, is a method of utilizing a recording mode 516 of the interactive reading assistance device 500. The method steps of method 400a-400b are at least partially illustrated as implemented in FIGS. 5A-5G. Illustrated in screens 500a-500g of FIGS. 5A-5G, the interactive reading assistance device 500 includes an interactive display 504 supported in a frame 502. In one example embodiment, the frame 502 supports the camera or recording device 506, the microphone 503, the speaker 505, and/or an input for an external microphone and/or speaker.

At 402 of the method 400a, responsive to a selection of an initiation mode selection element 510, illustrated in FIG. 5A, an initiation mode 500b is presented as illustrated in FIG. 5B, to a reader, the initiation mode including a recording mode option 516 and the reading mode option 716. At 404, as illustrated in FIG. 5B, responsive to receiving selection of the recording mode option 516, a text selection option 517 is presented, including one or more texts 202 having independent selection options 202a, 202b, 202c, 202d and/or a recording mode activation element 520. In one example embodiment, the recording mode activation element 520 is not selectable until an independent selection option 202a, 202b, 202c, or 202d of the one or more texts 202 has been utilized. In another example embodiment, the recording mode activation element 520 is selectable upon presentation to the reader, and a first independent selection option 202a is selected absent receiving a different selection.

At 406, as illustrated in FIG. 5C, responsive to the selection of a particular text of the one or more texts 202, intermediate text segment 204 are generated, and at least a first intermediate text segment 204a is presented to the reader. In one example embodiment, a numerical indicator 526a is presented to identify which intermediate text segment 204 a reader is viewing and/or how many intermediate text segments were generated from the particular text. As further illustrated as implemented in FIG. 5C, is a recording presentation 524. At 406, as illustrated in FIGS. 5C-5D, responsive to the selection of a recording option 522, the reader reading the first intermediate text segment 204a is recorded. The recording the reader reading, includes presenting an active recording icon 544 and an active recording presentation 524a, and presenting the reader with audio and/or video of their reading contemporaneously with the reading taking place. In one example embodiment, the active recording icon 544 is a stop recording selection element, wherein selection of the active recording icon 544 ceases recording and returns the active recording icon to the record option 522. In another example embodiment, the interactive reading assistance device 500 ceases recording after a designated time period, a period of silence has lapsed, or the like.

At 410, as illustrated in FIGS. 5C-5F, the reader is presented with first and second navigational elements 540a, 540b, used to navigate between intermediate text segments 204. In one example embodiments, the first and second navigational elements 540a, 540b are presented concurrently with the presentation of the first intermediate text segment 204a. In another example embodiments, the first and second navigational elements 540a, 540b are presented after recording the reader reading the first intermediate text segment 204a. At 412, as illustrated in FIGS. 5C-5F, responsive to the reader engaging the first navigational element 540a, synchronous next intermediate text segments 204b is presented until a last test segment is reached 204z (see FIG. 5I). At 414, as illustrated in FIGS. 5C-5F, responsive to the reader engaging the second navigational element 540b, synchronous previous intermediate text segments 204a are presented until a first text segment is reached 204a. At 416, steps 406-414 are repeated until an entirety (204a-204z) of the text 202 and intermediate text segment 204 have been presented to the reader and recorded.

At 418, as illustrated in FIGS. 5E-5F, responsive to a user selection of a recording option section element 542, the reader is presented with one or more recording options 525 including a review panel selection element 526c. In the illustrated example embodiment of FIG. 5F, the one or more recording options 525 include a back to beginning selection element 546b and a display warning selection element 546a, wherein selection of the display warning selection element 546a prompts a warning when the reader, by selecting the record option 522, will record over an existing video. Further wherein, selection of the back to beginning selection element 546b returns the reader to the first intermediate text segment 204a of the selected text 202. In another example embodiment, responsive to selection the recording option section element 542, the reader is presented with a back to main menu selection element 546d, which when selected will return the reader to a previous screen, such as screen 500c illustrated in FIG. 5C.

At 420, as illustrated in screens 500g-500i of FIGS. 5G-5I, responsive to receiving a selection of the review panel selection element 546c, a review panel 540 is generated and presented. The review panel 540 presents intermediate text segments 204 and/or identified elements 208 to the reader. The review panel 540 in other embodiments, presents speech sound elements 224 to the reader. At 422, as illustrated in screens 500g-500j of FIGS. 5G-5J, responsive to receiving a selection 529 (e.g., a visual indicator that a particular video/recording of intermediate text segments 204, speech sound elements 224, and/or identified elements 208 has been selected, such as a change in color, a check mark, etc.) at least one of a play element 544, a stop element 546, and/or a delete element 548 is presented to the user.

At 424, as illustrated in screens 500h-500i of FIGS. 5H-5I, responsive to the user selecting the play element 544, the selected particular video/recording of intermediate text segments 204, speech sound elements 224, and/or identified elements 208, the selected segment or element is played back to the reader on the recording presentation 524 (e.g., see, FIG. 5I). At 426, as illustrated in screens 500h-500i of FIGS. 5H-5I, responsive to the user selecting the stop element 546, the selected play back of the selected particular video/recording of intermediate text segments 204, speech sound elements 224, and/or identified elements 208 is stopped. In this example embodiment, the reader may select any video/recording of intermediate text segments 204, speech sound elements 224, and/or identified elements 208 and select the play element 544 to play the particular video/recording, and/or stop the particular video/recording.

At 428, as illustrated in screens 500h-500i of FIGS. 5H-5I, responsive to the user selecting the deletion element 548, the particular video/recording of intermediate text segments 204, speech sound elements 224, and/or identified elements 208 is deleted. In this example embodiment, a prompt to re-record the deleted video/recording of intermediate text segments 204, speech sound elements 224, and/or identified elements 208 is generated and presented to the reader, the re-record prompt including steps 406-408. Once completed, the reader may elect the read mode 716 illustrated in FIG. 5B.

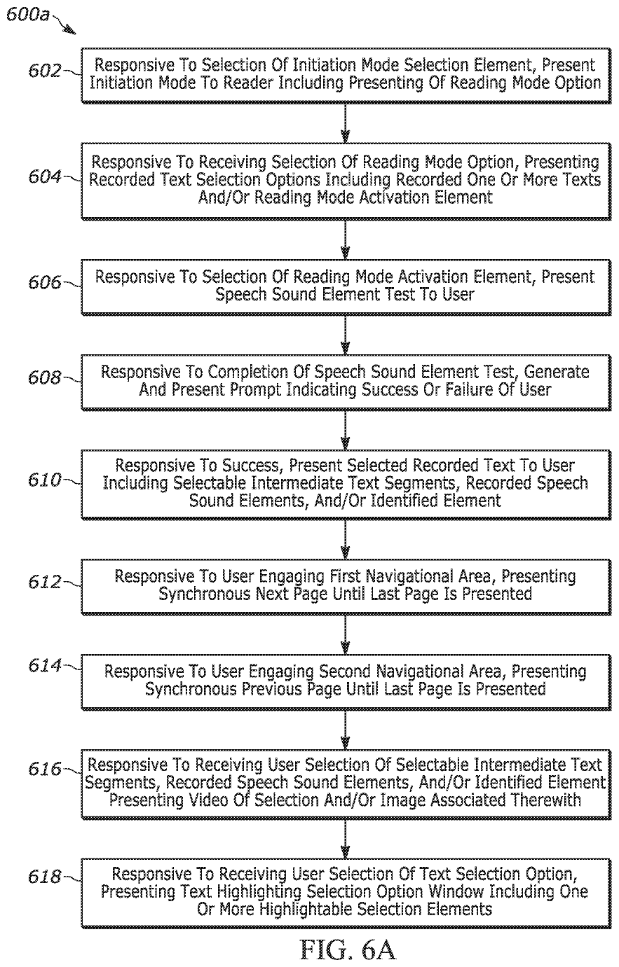

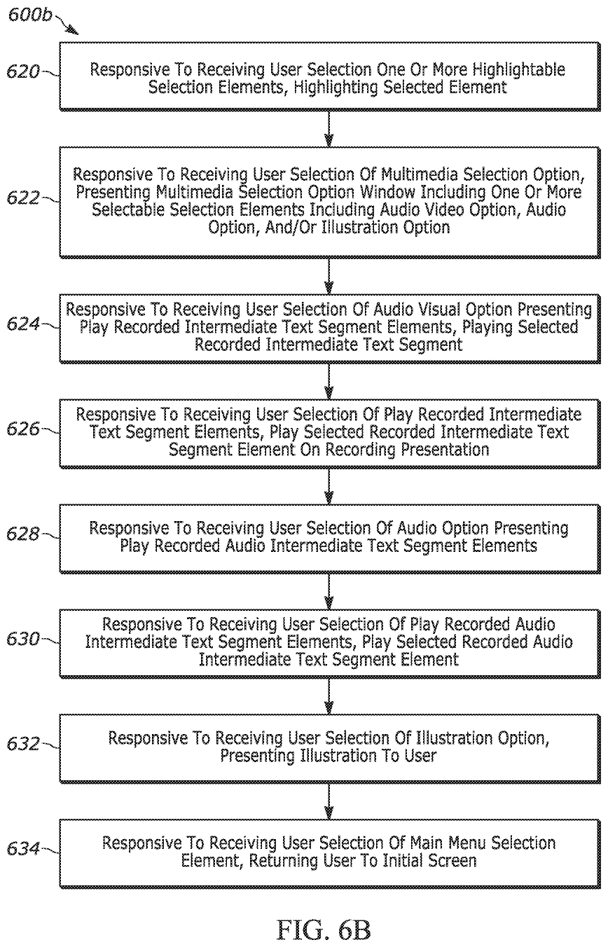

Illustrated in the example method 600a that continues to 600b of FIGS. 6A-6B, is a method of utilizing a reading mode 716 of the interactive reading assistance device 500. The method steps of method 600a-600b are at least partially illustrated as implemented in FIGS. 7A-7O. Illustrated in FIGS. 7A-7O, as in FIGS. 5A-5G, the interactive reading assistance device 500 includes the interactive display 504 supported by the frame 502.

At 602 of the method 600a, responsive to a selection of an initiation mode selection element 510, illustrated in FIG. 5A, presenting an initiation mode 700a, illustrated in FIG. 7A, to a user, the initiation mode including the recording mode option 516 and the reading mode option 716 is presented to the user. At 604, as illustrated in FIG. 7A, responsive to receiving a selection of the reading mode option 716, recorded text selection options 715 are presented to the user (e.g., generated as described in method 400a-400b of FIGS. 4A-4B) including one or more recorded texts 702 having independent selection options 702a, 702b, 702c, 702d and/or a reading mode activation element 720. In one example embodiment, the reading mode activation element 720 is not selectable until an independent selection option 702a, 702b, 702c, 702d of the one or more recorded texts 702 has been utilized. In another example embodiment, the reading mode activation element 720 is selectable upon presentation to the user, and a first independent selection option 702a is selected absent receiving a different selection.

At 606, as illustrated on screen 700b of FIG. 7B, responsive to the selection of a particular text of the one or more recorded texts 702 and the reading mode activation element 720, a speech sound element test 225 having particular speech sound elements 224 (e.g., such as aa sounds 224a, ss sounds 224b (plural sounds), ee sounds 224c, sh sounds 224d, mm sounds 224e, oo sounds 224f is presented to the user. In one example embodiment, the speech sound element test 225 is the Ling Six Sound Test that confirms auditory access. In another example embodiment, failure to confirm auditory access to one or more particular speech sounds 224 determines therapeutic objectives for the user. For example, in future or current sessions, texts 202 and/or recorded texts 702 that have an instance of the one or more particular speech sounds 224 that the user lacks auditory access to over a threshold are presented to the user. In another example embodiment, in recording mode 516 texts 202 that have instance of the one or more particular speech sounds 224 that the user lacks auditory access to over a threshold are presented to the reader to be recorded.

At 608, as illustrated on screen 700c of FIG. 7C, a prompt 703 is generated and presented to the user, the prompt includes indicators to select success 703a, or failure 703b. At 610, as illustrated on screens 700d-700o in FIGS. 7D-7O, responsive to the user indicating success 703a, selected recorded text 702 is presented to the user, the selected recorded text including selectable intermediate text segments 204, recorded speech sound elements 224 and/or identified elements 208. In this embodiment, a first page 706a of the selected recorded text 702 is presented to the user, (see FIG. 7D). At 612, as illustrated at least on screens 700d-700e of FIGS. 7D-7E, responsive to the user engaging a first navigational area 730b, a next page 706b is presented, until a last page is presented. At 614, as illustrated at least on screens 700d-700e of FIGS. 7D-7E, responsive to the user engaging a second navigational area 730a, a previous page 706a is presented, until the first page 706a is presented.

At 616, as illustrated in screens 700e-700f of FIGS. 7E-7F, responsive to receiving a user selection of the selectable intermediate text segments 204, recorded speech sound elements 224 and/or identified elements 208, an image or video associated therewith is presented to the user. As illustrated in FIG. 7F, the user selected the identified element 208b “baseball”, an image 708 of a person playing baseball is presented to the user. The user is presented with an exit icon 714, wherein selected the screen 700f reverts to a previous screen such as screen 700e.

At 618, as illustrated in screens 700g-700k of FIGS. 7G-7K, responsive to receiving a user selection of a text selection option 712, a text highlighting selection option window 712a including one or more highlightable section elements 716 is presented to the user. At 620, as illustrated in screens 700g-700k of FIGS. 7G-7K, responsive to receiving a user selection of the one or more highlightable section 716, the selected element is highlighted (e.g. visually differentiated). In this example embodiment, the one or more highlightable section elements 716 include highlighting a first letter 716a. As illustrated in the example embodiment of screen 700i, wherein a user selected the letter g 720, words starting with the letter g are highlighted 720b, (see for example, grumpy, grump, get, got, etc.). In this example embodiment, different first letters 716a once selected have different visual indicators (e.g. colors) to highlight different letters. In the example embodiment, more than one first letters 716a may be selected and highlighted. The user is presented with a hide element 718a, which when selected will remove the text highlighting selection option window 712a from the user's view, and a reset element 718b, which when selected will reset the text highlighting selection option window 712a to an original condition (e.g., the user selections are removed). The user is presented with an exit element 718c, which when selected will close the text highlighting selection option window 712a. The text highlighting selection option window 712a includes a navigation bar 722 that when selected scrolls through the one or more highlightable section elements 716.

In this example embodiment, the one or more highlightable section elements 716 include highlighting parts of speech 716b. As illustrated in the example embodiment of screen 700j, the user is presented with nouns, adjectives, verbs, articles, pronouns, and other parts of speech. Wherein the user may select a part of speech, and differentiate between proper and improper nouns, etc. as illustrated in FIG. 7K. In the illustrated example of screen 700k of FIG. 7K, wherein a user selected a noun-people 720c, nouns that refer to people are highlighted 720d, (see for example, Davy Duck, Someone, etc.). In this example embodiment, different parts of speech 716b once selected have different visual indicators (e.g. colors, designs, fonts, indicators such as italics, underlining, etc.) to highlight different selected parts of speech. In the example embodiment, more than one part of speech 716b may be selected and highlighted. In this example embodiment, the one or more highlightable section elements 716 include highlighting auditory training, wherein the element selected is audibly recited for the user.

At 622, as illustrated in screens 700l-700o of FIGS. 7L-7O, responsive to receiving a user section of the multimedia selection option 710, the multimedia section option window 710a is presented, the multimedia selection option window includes multiple options 726, including an audio video option 726a, an audio option 726b, and/or an illustration option 726c. At 624, responsive to receiving a user selection of the audio visual option 726a, as illustrated in FIG. 7L, play recorded icons 703 are presented. In this example embodiment, a first play recorded icon will instigate playing of the first recorded intermediate text segment 704a which corresponds to the first intermediate text segment 204a, a second play recorded icon 703 will instigate playing of the second recorded intermediate text segment 704b which corresponds to the second intermediate text segment 204b, a third play recorded icon 703 will instigate playing of the third recorded intermediate text segment 704c which corresponds to the third intermediate text segment 204c, wherein play recorded icons are generated to correspond to one or all of the additional intermediate text segments 204, until the last intermediate text segment 204z.

At 626, as illustrated in FIGS. 7L and 7N, responsive to receiving a user selection of the play recorded icon 703, the selected recorded intermediate text segment 704 (e.g., that the reader previously recorded) is played on the recording presentation 524. In this example embodiment, the selected intermediate text segment 204 (in this case the first intermediate text segment 204a) is presented to the user. Further, in this example embodiment, the play option 544 to play the reader recorded selected intermediate text segment 204 and the stop option 546 to stop playing the reader recorded selected intermediate text segment are presented to the user. In another example embodiment, as illustrated in FIGS. 7L and 7M, responsive to receiving a user selection of the second identified element 208b, the recording of the selected second identified element 208b is presented on the recording presentation 524. In this example embodiment, the second identified element 208b is baseball. In this embodiment, the image 708a of a baseball player is presented to the user, along with the recording presentation 524, the play option 544 to play the reader recorded selected identified element 208 and/or the intermediate text segment 204 containing the selected identified element. The exit icon 714 is presented to allow, upon user selection, the user to return to the reading view of 700I from either of screens 700m of 700n.

At 628, responsive to receiving a user selection of the audio option 726b, as illustrated in FIG. 7O, play audio of intermediate text segment elements 705 are presented. In this example embodiment, a first play audio intermediate text segment element 705a includes the audio from the first recorded intermediate text segment 704a and corresponds to the first intermediate text segment 204a, a second play audio intermediate text segment element 705b includes the audio from the second recorded intermediate text segment 704b and corresponds to the second intermediate text segment 204b, a third play audio intermediate text segment element 705c includes the audio from the third recorded intermediate text segment 705c and corresponds to the third intermediate text segment 204c, wherein the play audio intermediate text segment elements 705 are generated to correspond to one or all of the additional intermediate text segments 204, until the last intermediate text segment 204z.

At 630, as illustrated in FIG. 7O, responsive to receiving a user selection of the play audio intermediate text segment element 705, the selected audio intermediate text segment (e.g., that the reader previously recorded) is played while the text of the page 706 is presented to the user. In this example embodiment, the user selects, for example, the first audio intermediate text segment 705a, and audio of the recording 704a generated by the reader is played. The user may select any intermediate text segment 705 presented. At 632, responsive to receiving a user selection of the illustration option 726c, as illustrated in FIG. 7O, one or more illustrations 728 are presented in the text of the pages 706. In another example embodiment, the one or more illustrations 728 are from the original text. In yet another example embodiment, the one or more illustrations 728 are presented in a separate page 706 from the text.

The user may continue to read the text 202, change the text highlight option 712a, the multimedia options 710, and/or utilize the first and/or second navigational areas 730b, 730a to navigate and/or finish the text. At 634, responsive to receiving a user selection of the main menu selection element 546d, the user is returned to the initial screen (e.g., either screen 700a, or screen 700d).

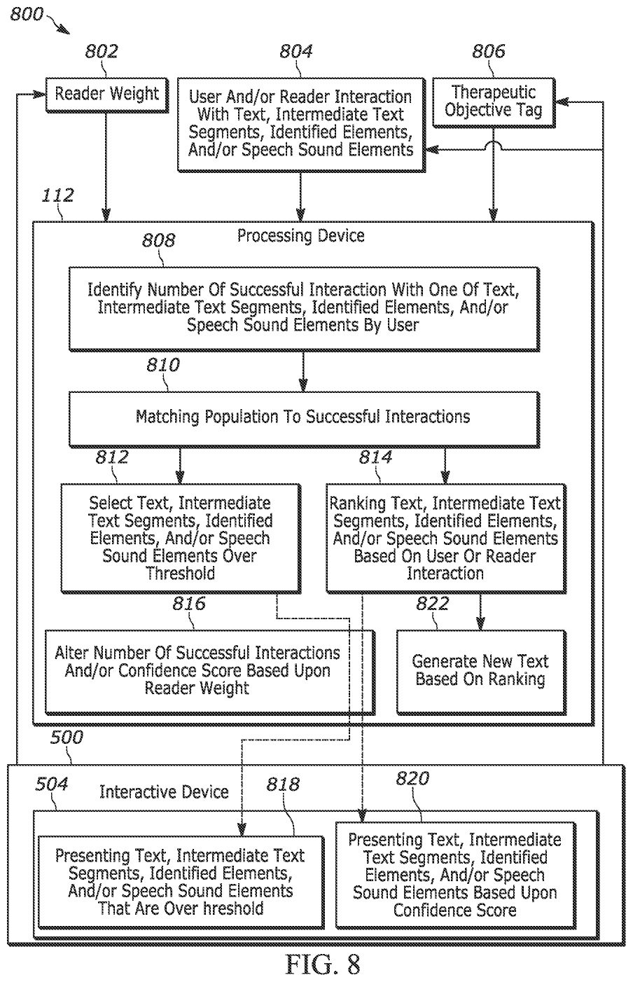

Illustrated in FIG. 8 is a method 800 of using the interactive reading assistance system 100, including inputs and outputs utilized in ranking text 202, intermediate text segments 204, one or more identified elements 208, and/or one or more speech sound elements 224 as preferred or efficacious for a given population. In one example embodiment, the population includes only those that have a common therapeutic objective tag. The therapeutic objective is identified for populations having one of a learning impairment, autism, dyslexia, English as a second language (ESL), and/or a delayed reader. In one example embodiment, the population includes developmentally normal children, as well as developmentally abnormal children. In another example embodiment, the given population is all users of the interactive reading assistance system 100 regardless of therapeutic objective, or age.

In one example embodiment, preferred or efficacious text 202, intermediate text segments 204, or elements 208, 224 are ranked based upon the iterative feedback from the interactive reading assistance system 100. At 802, the processing device, as part of a local or a remote computer system 121, receives reader confidence scores from the reader based upon the reader's observed interaction of the user with a given text 202, intermediate text segments 204, and/or elements 208, 224. In one example embodiment, the processing device 112 provides the reader with an option to weight the text 202, intermediate text segments 204, and/or elements 208, 224 from along a value scale (e.g., 1-5). At 804, the processing device 112 receives at least one of the reader's and/or the user's interaction with the interactive display 504 as well as an identifier of the population to which the user is a member. At 806, the processing device 112 receives the therapeutic objective tag of the user. In this embodiment, the therapeutic objective tag identifies the population.

At 808, the processing device 112 identifies a number of successful interactions with one of text 202, intermediate text segments 204, one or more identified elements 208, and/or one or more speech sound elements 224. In this example embodiment, the ranking is generated through the user and/or the reader interacting with the interactive display 504. In one example embodiment, successful interactions include user engaging navigational areas 730 (as in steps 612, 614 of method 600 illustrated in FIG. 6A), selection of selectable text 202, intermediate text segments 204, or elements 208, 224 (as in step 616 of method 600 illustrated in FIG. 6A), user section of the multimedia selection option 710, the audio visual option 726a, the play recorded icon 703, the audio option 726b, and/or the play audio intermediate text segment element 705 (as in steps 622-630 of method 600 illustrated in FIG. 6A). At 810, the processing device 112 matches populations to successful interactions, including the population of all users and/or populations having a specific therapeutic objective tag.

At 812, the processing device 112 selects the text 202, intermediate text segments 204, and/or elements 208, 224 that have received a threshold number of successful interactions. The text 202, intermediate text segments 204, and/or elements 208, 224 that have received the threshold number of successful interactions are selected by the processing device 112 to be presented to the reader and/or the user, and the text 202, intermediate text segments 204, and/or elements 208, 224 that are below the threshold are not presented to the reader and/or the user on the interactive reading assistance system 100

At 814, the processing device 112 ranks the text 202, intermediate text segments 204, and/or elements 208, 224 relative to the successful interactions' relationship by assigning a confidence score to the match, wherein a highest confidence score has a highest number of successful interactions. In one example embodiment, the confidence score is based on one or more filters (including population type, time of engagement, location of intermediate text segments 204, and/or elements 208, 224 relative to the beginning and/or end of the text 202, and/or an overall length of the text). In one embodiment, the ranking is based on a combination of filters. In this example embodiment, the confidence score establishes the threshold number of successful interactions. In this example embodiment, the highest ranked text 202, intermediate text segments 204, and/or elements 208, 224 are presented to the user or reader in descending order of confidence score.

At 816, when the reader weight is provided, the processing device 112 alters the confidence score of the text 202, intermediate text segments 204, and/or elements 208, 224 based upon the weight provided by the reader. In another example embodiment, the processing device 112 boosts the number of successful interactions of the text 202, intermediate text segments 204, and/or elements 208, 224 based upon the weight provided by the reader. The boost may or may not cause the text 202, intermediate text segments 204, and/or elements 208, 224 to exceed the threshold.

At 818, the text 202, intermediate text segments 204, and/or elements 208, 224 over the threshold are presented on the interactive device 500. At 820, the processing device 112 instructs that the text 202, intermediate text segments 204, and/or elements 208, 224 having a confidence score over the threshold are presented on the interactive device 500. In one example embodiment, the text 202, intermediate text segments 204, and/or elements 208, 224 are presented from highest confidence score to lowest confidence score.

The processing device 112 is iteratively or continually assigning the various text 202, intermediate text segments 204, and/or elements 208, 224 a confidence score and/or are identifying the various text 202, intermediate text segments 204, and/or elements 208, 224 as over the threshold number of interactions, based upon the user interaction and/or the reader weight. At 822, the processing device 112 utilizes intermediate text segments 204, or elements 208, 224 having high confidence scores, e.g., scores over a creation threshold, and generate more effective text 202. In one example embodiment, the intermediate text segments 204, or elements 208, 224 have a confidence score assigned based upon the population. For example, specific speech sound elements 224 will have a higher confidence score for a particular population (e.g., ESL children), in that instance, an ESL text will be generated that includes a higher instance of that specific speech sound element. The ESL text will be presented more often, and more prominently to users having identified as ESL students as compared to the general population.

The interactive reading assistance system 100 enables parents and speech-language therapists (readers) to partner together to help children and adults (users) achieve reading, speech, and language goals through interactive digital storybook reading, music, and/or singing.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 100%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An interactive reading assistance system for assisting users read, the interactive reading assistance system comprising:
an interactive reading assistance device comprising an interactive display defining a touch screen area;
a processing device in communication with the interactive reading assistance device, the processing device having a processor configured to perform logic functions based upon user inputs on the interactive reading assistance device, the processing device comprising memory, wherein one or more texts are parsed into at least one of intermediate text segments, identified elements, and speech sound elements, assigned tags, and stored in the memory, the processing device provides instruction to the interactive reading assistance device to present the one or more texts to a reader in a recording mode;
presenting a prompt to the reader to read and record at least one of intermediate text segments, the identified elements, and the speech sound elements identified based upon input therapeutic goals based upon the assigned tags;
storing the recorded at least one of intermediate text segments, identified elements, and speech sound elements in memory;
matching the recorded at least one of intermediate text segments, identified elements, and speech sound elements to the at least one of intermediate text segments, identified elements, and speech sound elements present in the one or more texts;
providing instruction to the interactive reading assistance device to present the one or more texts to a user in a reading mode;
responsive to the user selecting a text of the one or more texts, options to view the recorded at least one of intermediate text segments, identified elements, and speech sound elements associated with the respective at least one of intermediate text segments, identified elements, and speech sound elements are presented; and
responsive to the user selection of an option to view a respective intermediate text segment, identified element, or speech sound element, the recording matched to that respective intermediate text segment, identified element, or speech sound element is played.

2. The interactive reading assistance system of claim 1, wherein the user is one of learning or hearing impaired.

3. The interactive reading assistance system of claim 1, wherein the one or more texts comprise music and lyrics.

4. The interactive reading assistance system of claim 1, wherein the one or more texts are accompanied by music when selected by the user.

5. The interactive reading assistance system of claim 1, wherein responsive to receiving a user selection of a text selection option, providing instruction to the interactive reading assistance device to present one or more highlightable section elements to the user.

6. The interactive reading assistance system of claim 5, wherein the one or more highlightable section elements include highlighting a first letter, wherein responsive to receiving a selection of a first letter, providing instruction to the interactive reading assistance device to present a first visual indicator to highlight the first letter.

7. The interactive reading assistance system of claim 6, wherein responsive to receiving a selection of a second letter providing instruction to the interactive reading assistance device to present a second visual indicator to highlight the second letter, the first visual indicator different than the second visual indicator.

8. The interactive reading assistance system of claim 5, wherein the one or more highlightable section elements include highlighting parts of speech, wherein responsive to receiving a selection of a first part of speech providing instruction to the interactive reading assistance device to present a first visual indicator to highlight the first part of speech.

9. The interactive reading assistance system of claim 8, wherein responsive to receiving a selection of a second part of speech providing instruction to the interactive reading assistance device to present a second visual indicator to highlight the second part of speech, the first visual indicator different than the second visual indicator.

10. The interactive reading assistance system of claim 5, wherein the one or more highlightable section elements include highlighting auditory training, wherein responsive to receiving a selection of an auditory training element providing instruction to the interactive reading assistance device to audibly recite the recorded at least one of intermediate text segments, identified elements, and speech sound elements that corresponds to the auditory training element selected.

11. A non-transitory computer readable medium storing instructions executable by an associated processor to perform a method for implementing an interactive reading assistance system comprising:
parsing one or more texts into at least one of intermediate text segments, identified elements, and speech sound elements;
assigning tags to the intermediate text segments, the identified elements, and the speech sound elements;
identifying a population of a user;
assigning a therapeutic objective tag to the user to identify the user population;
responsive to interaction of the user with a particular intermediate text segments, identified elements, and speech sound elements, identifying the interaction as successful or unsuccessful within the population of the user;
ranking particular intermediate text segments, identified elements, and speech sound elements based upon number of successful interactions identified; and
generating a population specific text comprising the intermediate text segments, identified elements, and speech sound elements having a rank over a rank threshold.

12. The method of claim 11, comprising presenting the population specific text to the user on an interactive reading assistance device.

13. The method of claim 11, the population including the user who is one of learning delayed, hearing impaired, or developmentally normal.

14. The method of claim 11, further comprising providing instruction to an interactive reading assistance device to present the population specific text to a reader in a recording mode, and presenting a prompt to the reader to read and record at least one of intermediate text segments, identified elements, and speech sound elements identified based upon an input population of the user.

15. The method of claim 14, further comprising providing instruction to the interactive reading assistance device to present the population specific text to the user in a reading mode.

16. The method of claim 14, further comprising responsive to the user selecting population specific text, presenting options to view the recorded at least one of intermediate text segments, identified elements, and speech sound elements associated with the respective at least one of intermediate text segments, identified elements, and speech sound elements.

17. The method of claim 11, the parsing the one or more texts comprising parsing music and lyrics.

18. The method of claim 11, the parsing the one or more texts comprising parsing one or more texts accompanied by music.

19. A non-transitory computer readable medium storing instructions executable by an associated processor to perform a method for implementing an interactive reading assistance system comprising:
parsing one or more texts into at least one of intermediate text segments, identified elements, and speech sound elements;
assigning one or more assigned tags to the parsed intermediate text segments, identified elements, and speech sound elements;
providing instruction to an interactive reading assistance device of the interactive reading assistance system to present the one or more texts to a reader in a recording mode;
presenting a prompt to the reader to read and record at least one of intermediate text segments, identified elements, and speech sound elements identified based upon input therapeutic goals based upon the assigned tags;
storing the recorded at least one of intermediate text segments, identified elements, and speech sound elements in memory;
matching the recorded at least one of intermediate text segments, identified elements, and speech sound elements to the at least one of intermediate text segments, identified elements, and speech sound elements present in the one or more texts;
providing instruction to the interactive reading assistance device to present the one or more texts to a user in a reading mode;
providing a text selection option to the user on the interactive reading assistance device;
responsive to receiving a user selection of the text selection option, providing instruction to the interactive reading assistance device to present one or more highlightable section elements to the user;
providing an auditory training element option to the user on the interactive reading assistance device; and
responsive to receiving a selection of the auditory training element, providing instruction to the interactive reading assistance device to audibly recite the recorded at least one of intermediate text segments, identified elements, and speech sound elements that corresponds to the auditory training element selected.

20. The method of claim 19, the parsing the one or more texts comprising at least one of parsing music and lyrics or parsing one or more texts accompanied by music.
